(19) United States
(12) Patent Application Publication
(10) Pub. No.: US 2019/0280485 A1
(43) Pub. Date: Sep. 12, 2019

(54) ENERGY STORAGE SYSTEM AND MANAGEMENT APPARATUS

(71) Applicant: HONDA MOTOR CO., LTD., Tokyo (JP)

(72) Inventors: Masashi KISHI, Tokyo (JP); Tomohide HARAGUCHI, Wako-shi (JP)

(21) Appl. No.: 16/250,487

(22) Filed: Jan. 17, 2019

(30) Foreign Application Priority Data
Mar. 8, 2018 (JP) 2018-042251

(51) Int. Cl. H02J 3/38; C10G 1/00

(52) U.S. Cl. CPC H02J 3/382; C10G 1/00

(57) ABSTRACT

An energy storage system comprises: a generation unit configured to generate liquid fuel using power by renewable energy; a storage unit configured to store the liquid fuel generated by the generation unit; and a storage amount management unit configured to control the generation unit and monitor a storage amount in the storage unit, wherein when the storage amount in the storage unit exceeds a predetermined threshold, the storage amount management unit performs switching such that the power is operated by an operation company of power.

### CROSS-REFERENCE TO RELATED APPLICATION

This application claims priority to and the benefit of Japanese Patent Application No. 2018-042251, filed on Mar. 8, 2018, the entire disclosure of which is incorporated herein by reference.

### BACKGROUND OF THE INVENTION

### Field of the Invention

The present invention relates to an energy storage system and a management apparatus and, more particularly, to a technique of managing and effectively using biomass managed in a region.

### Description of the Related Art

Conventionally, biomass resources are collected/managed in a municipality or a region in a predetermined range and used according to a purpose. For example, biomass power generation is performed or a storable biofuel is generated using a biomass resource. Examples of a biomass resource usable for biomass power generation are waste wood, combustible garbage, and waste oil.

In addition, various kinds of power generation facilities are managed using a facility such as a CEMS (Community Energy Management System), and the supply and demand of power in a region are optimized.

Japanese Patent Laid-Open No. 2002-193858 describes that hydrogen manufactured by power using natural energy is used in an apparatus configured to generate methanol by gasifying a biomass fuel and synthesizing it with hydrogen.

In addition, Japanese Patent Laid-Open No. 2010-35395 discloses a system configured to receive power from a power transmission network for power generated using renewable energy and manufacture/store hydrogen. Japanese Patent Laid-Open No. 2010-35395 also describes that the hydrogen manufacturing amount is adjusted, or the power generation amount of renewable energy is increased based on the power supply/demand of the power transmission network. In addition, concerning a system that functions as an infrastructure, Japanese Patent Laid-Open No. 2016-92867 describes a system configured to switch supply/demand adjustment concerning power and water in normal time and in case of disaster.

In Japanese Patent Laid-Open No. 2002-193858, handling of surplus power is not taken into consideration in the above-described CEMS. In Japanese Patent Laid-Open No. 2010-35395, management of storage of liquid fuel is not taken into consideration. In Japanese Patent Laid-Open No. 2016-92867, efficient collection of a material concerning biomass power generation is not taken into consideration.

Additionally, in a form of a biomass resource (to be also referred to as a biomass material), a suppliable energy amount is difficult to predict. For this reason, the biomass material is preferably changed to liquid fuel such as bioethanol from the viewpoint of long-term storage and easy handling.

### SUMMARY OF THE INVENTION

The present invention appropriately supplies and operates surplus power obtained by power generation using a collected resource while effectively using a resource in a region and ensuring liquid fuel.

According to one aspect of the present invention, there is provided an energy storage system comprising: a generation unit configured to generate liquid fuel using power by renewable energy; a storage unit configured to store the liquid fuel generated by the generation unit; and a storage amount management unit configured to control the generation unit and monitor a storage amount in the storage unit, wherein when the storage amount in the storage unit exceeds a predetermined threshold, the storage amount management unit performs switching such that the power is operated by an operation company of power.

According to another aspect of the present invention, there is provided a management apparatus comprising: an acquisition unit configured to acquire information of a storage amount in a storage unit configured to store liquid fuel generated by a generation unit using power by renewable energy; and an instruction unit configured to, when the storage amount in the storage unit exceeds a predetermined threshold, instruct switching of supply of power such that the power is used for an application purpose different from generation of the liquid fuel by the generation unit.

According to the present invention, it is possible to appropriately supply and operate surplus power obtained by power generation using a collected resource while effectively using a resource in a region and ensuring liquid fuel.

Further features of the present invention will become apparent from the following description of exemplary embodiments (with reference to the attached drawings).

### BRIEF DESCRIPTION OF THE DRAWINGS

FIG. 1 is a block diagram showing the schematic arrangement of a system according to an embodiment of the present invention;

FIG. 2 is a block diagram showing an example of the hardware arrangement of an information processing apparatus according to the present invention;

FIG. 3 is a view for explaining a procedure concerning biomass power generation according to the present invention;

FIG. 4 is a view for explaining the concept of the arrangement of the information processing apparatus according to the present invention;

FIG. 5 is a flowchart of processing according to the embodiment; and

FIG. 6 is a flowchart of processing concerning transaction management according to the embodiment.

### DESCRIPTION OF THE EMBODIMENTS

An embodiment of the present invention will now be described with reference to the accompanying drawings. Note that an arrangement and the like to be described below are merely examples, and are not limited to these.

[System Arrangement]

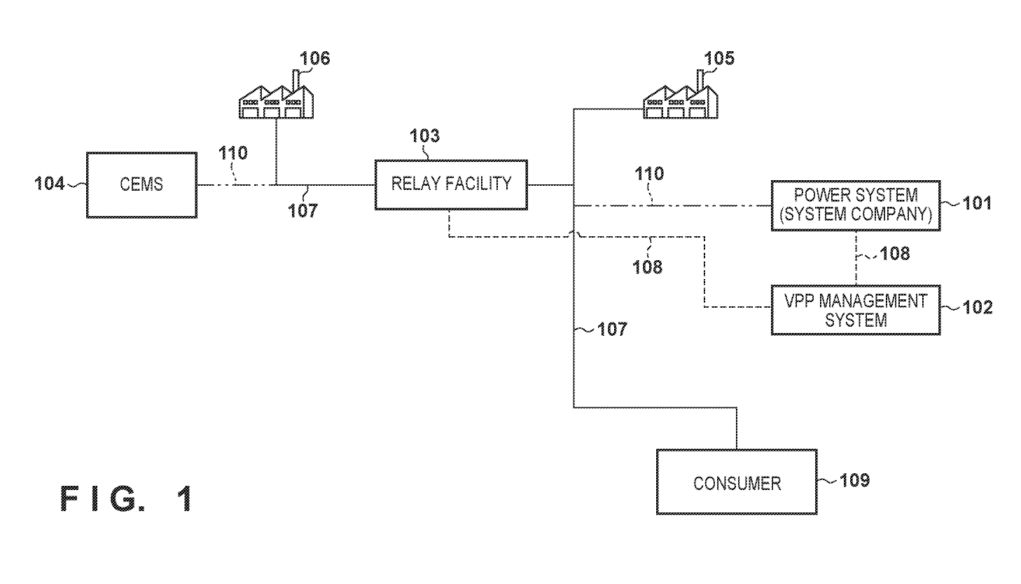

FIG. 1 is a schematic view of an entire system according to the present invention. Referring to FIG. 1, an electric power system 107 is a network including a power distribution facility (supply line), a power transmission facility, and a transformer facility, and is indicated by a solid line here. A communication line 108 is a communication line for data and the like and is indicated by a broken line here. A monitoring line 110 is a communication line concerning monitoring of the electric power system 107 and is indicated by an alternate long and two short dashed line here.

A power system 101 is, for example, a system provided by a system company that manages power supply facilities and electric wiring and the like of the electric power system 107 and configured to manage supply of power, power generation, and the like. The system company corresponds to, for example, an electric power company including a large-scale power plant, and supplies power to a consumer 109 based on a contract, or the like. Here, a power plant 105 is assumed to be managed by the system company.

A VPP management system 102 is a system provided by a company that provides/manages a VPP (Virtual Power Plant) service, and manages and operates supply (distribution) of power from each power generation base. The company that provides and manages the VPP service here corresponds to the above-described system company, an electric power company, a service provider, or the like but is not particularly limited. Here, the company that provides/manages the VPP service will be described as an operation company of power.

A relay facility 103 performs control concerning relay management of power of a facility including a power generation facility and switching of consumption and supply of power. The relay facility 103 controls switching of the electric power system 107 in cooperation with the VPP management system 102 so as to supply power generated by a corresponding power generation facility to the consumer 109 that requests power. In addition, when a corresponding facility requests power supply, the relay facility 103 switches the electric power system 107 so as to receive power supply from an external unit. In FIG. 1, the relay facility 103 corresponds to a power generation facility provided in a predetermined region. As an example of the power generation facility, a biomass power generation facility 106 in which biomass power generation is performed will be described. Additionally, in this embodiment, a CEMS (Community Energy Management System) 104 is provided as a system configured to manage and monitor the power generation facility (biomass power generation facility 106) provided in the predetermined region. The CEMS 104 is a management system installed in the predetermined region and configured to manage demand and supply of power.

One or a plurality of consumers 109 are connected to the electric power system 107, and request and consume power based on a contract with the system company, or the like. Note that in FIG. 1, a power generation facility managed by the system company is shown as the power plant 105. Additionally, in this embodiment, the CEMS 104 can also serve as a consumer by receiving power supplied from another power generation facility. Note that the power generation method of the power plant 105 managed by the system company is not particularly limited.

[Hardware Arrangement]

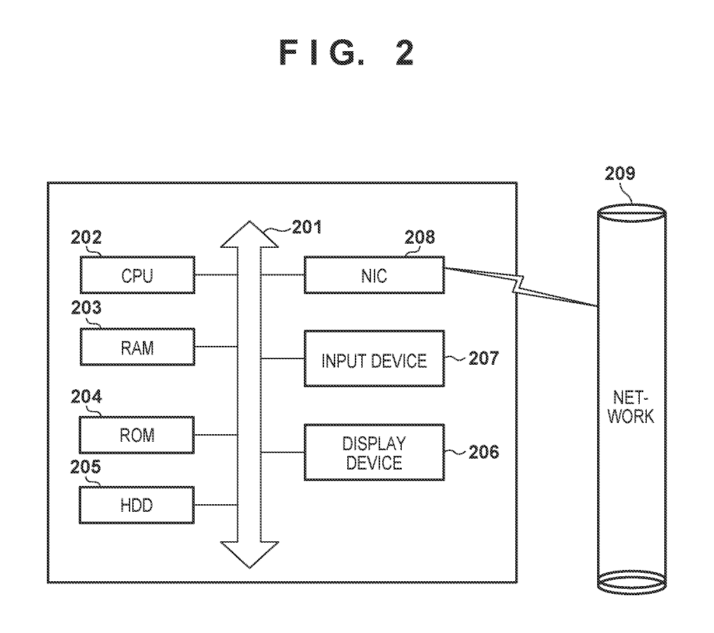

FIG. 2 is a block diagram showing an example of the hardware arrangement of an information processing apparatus provided in the CEMS 104, the VPP management system 102, or the relay facility 103 according to this embodiment. Although a general computer will be exemplified here, the information processing apparatus is not limited to this.

The information processing apparatus is communicably connected to an external apparatus via a network 209. The information processing apparatus includes a CPU (Central Processing Unit) 202, a RAM (Random Access Memory) 203, a ROM (Read Only Memory) 204, an HDD (Hard Disk Drive) 205, a display device 206, an input device 207, and a NIC (Network Interface Card) 208. These are communicably connected via a bus 201 in the apparatus. The CPU 202 reads out a program stored in the HDD 205 and executes it, thereby executing various kinds of processing. The RAM 203 is a volatile storage area and is used as a work memory or the like. The ROM 204 is a nonvolatile storage area. The HDD 205 is a nonvolatile recording area and holds various kinds of programs and data according to this embodiment. The display device 206 displays a screen such as a UI (User Interface). The input device 207 is used to receive an input of an instruction or the like from a user. The NIC 208 controls communication between the information processing apparatus and the network 209. The network 209 is formed by one or a plurality of networks such as LAN (Local Area Network), WAN (Wide Area Network), and the Internet. In addition, the communication method can be either a wired or wireless method here.

[CEMS]

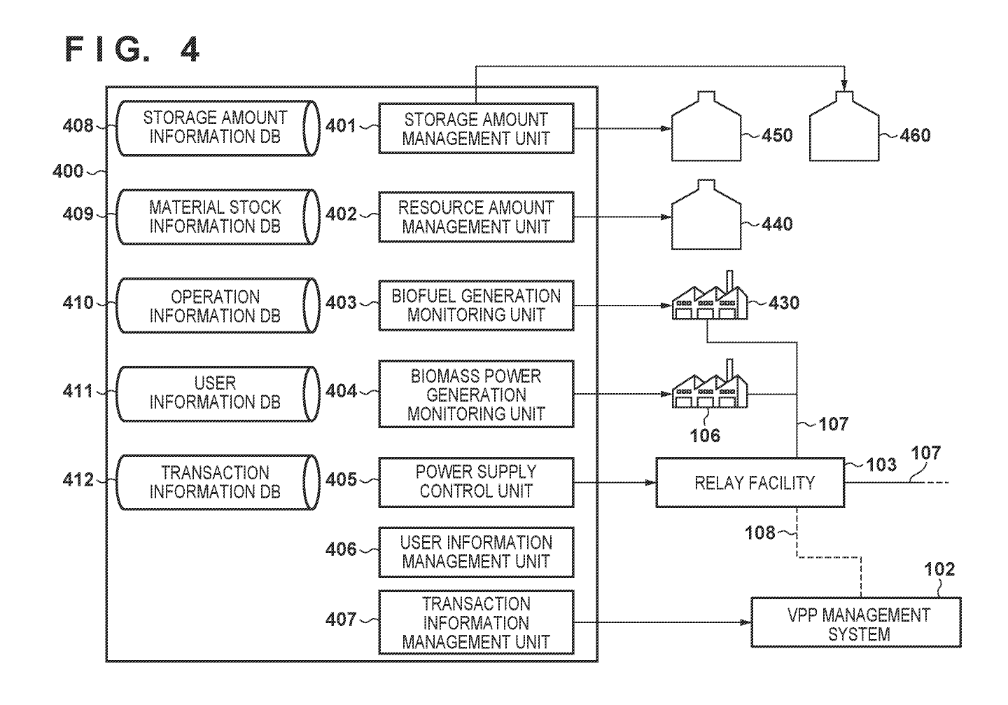

The function of a regional facility associated with the CEMS 104 used in this embodiment will be described next. A basic procedure of work in a facility associated with the CEMS 104 according to this embodiment is as follows. Note that the schematic arrangement of the facility associated with the CEMS 104 will be described later with reference to FIG. 4. Additionally, in the following explanation, biomass power generation and liquid fuel will be exemplified. However, the present invention is not limited to this, and is applicable to a power generation method executable using a material collected in a predetermined region. In addition, the present invention may be applied to a storable fuel.

1. A biomass power generation facility provided in a predetermined region accepts biomass resources including a plurality of types of materials in the predetermined region. The providing source of the biomass resources is not particularly limited and corresponds to, for example, a company, an organization, an individual, or the like.

2. The accepted biomass resources are divided into (1) materials to be used for biomass power generation, (2) materials serving as the materials of fuel to be stored, and (3) resources that can directly be stored.

3. Biomass power generation is performed using (1) to generate power. At this time, if a product (fuel) to be stored is generated along with the power generation, the product is stored as in 4. to be described below.

4. Fuel to be stored is generated using the power generated in 3. and (2), and the fuel is stored and managed. (3) is also stored and managed. In this step, if the power generated in 3. is insufficient, power supply from an external unit is received. That is, the facility associated with the CEMS 104 serves as a consumer.

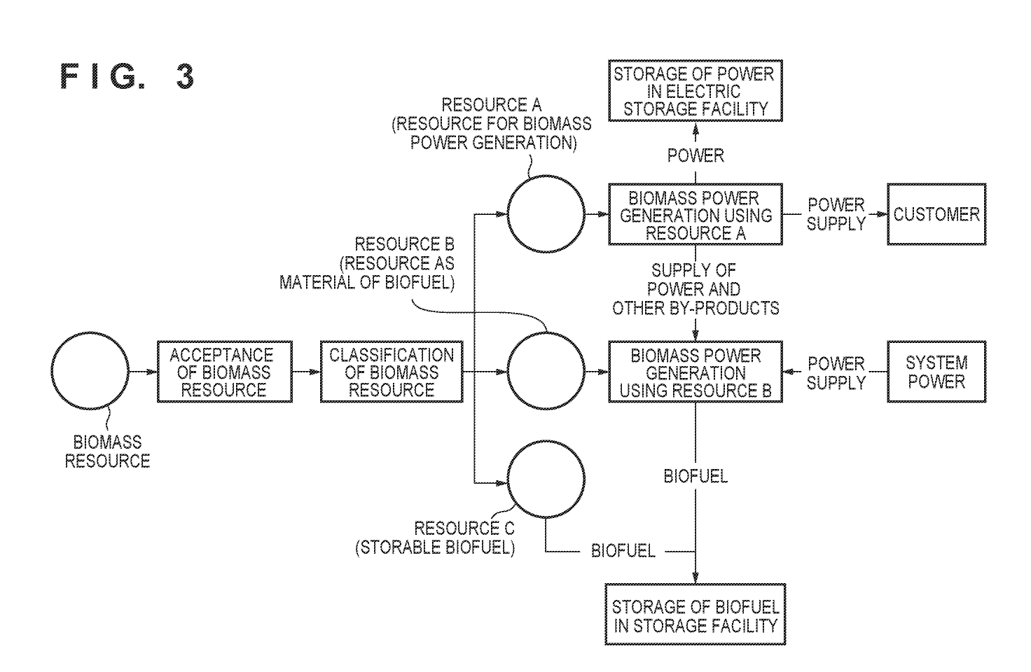

FIG. 3 shows a conceptual procedure in the facility associate with the CEMS 104 according to this embodiment. First, provided biomass resources are accepted. Next, the accepted biomass resources are classified in accordance with functions and application purposes. An explanation will be made here assuming that the biomass resources are classified into three types, a resource A, a resource B, and a resource C. Note that in fact, the biomass resources may be classified in more detail in each classification of the resources and divided on a function basis.

The resource A is a resource to be used for biomass power generation and corresponds to, for example, organic garbage such as feces and urine of livestock, food waste, and woody waste materials. The resource B is a resource as a material of biofuel. There are various materials depending on the biofuel to be generated. Examples are cultivated crops (sugar cane, corn, and the like) and waste (for example, kitchen waste). The resource C is a storable biofuel. Examples of the storable biofuel are liquid fuels such as bioethanol and biodiesel (BDF). However, the types of biofuel are not particularly limited, and any biofuel can be used as long as it is storable.

Biomass power generation is performed using the resource A. Power generated at this time is provided to an external consumer. The power is also used to generate biofuel in a facility or used as a power supply in a facility associated with the CEMS 104. By-products (for example, heat and light) generated by the biomass power generation can also be used to generate biofuel.

A storable biofuel is generated in the facility using the resource B. As described above, when generating biofuel, the power generated by the biomass power generation or power from an external system power supply is received. In addition, the by-products obtained by the biomass power generation in the facility can also be used.

The biofuel generated using the resource B or the resource C is stored and managed, and used (consumed) as needed.

The amount of the biofuel that can be stored in a facility (for example, a storage warehouse or a tank) used to store the biofuel has an upper limit. For this reason, even if the material used to generate the biofuel is sufficiently held, the amount of the biofuel that can be generated has an upper limit. On the other hand, in the biomass power generation, if the power is not used to generate the biofuel, the power can be supplied to an external consumer. Note that in a state in which the biomass power generation cannot be performed because of a shortage in the material (resource A), if the resource B exists, and the biofuel can be stored, power from an external system power supply is received.

Note that in the above-described classification, a material of biofuel has been exemplified as the resource B. However, the present invention is not limited to this classification. For example, the present invention may be applied to an arrangement for generating a diesel fuel (synthetic fuel) by power, CO₂, and hydrogen. In such an arrangement, the resource B may include not only the above-described biomass resource but also CO₂ and hydrogen. If resources that can be used to generate the synthetic fuel as described above are generated as the by-products of the biomass power generation using the resource A, the resources may be used, as a matter of course.

[Software Configuration]

FIG. 4 conceptually shows an example of the software configuration of the information processing apparatus functioning as the CEMS 104 according to this embodiment and the relationship of the peripheral facilities. The same reference numerals as in FIG. 1 denote the same components in FIG. 4. Note that the apparatuses, facilities, and various kinds of databases will be described as an arrangement. However, the present invention is not limited to this arrangement, and they may be distributed to a plurality of facilities and the like. In addition, for the sake of simplicity, the description will be made here using a simple drawing, but each monitoring unit may cooperate with a detection means such as a sensor.

An information processing apparatus 400 monitors each facility associated with the CEMS 104 and manages data. The information processing apparatus 400 includes a storage amount management unit 401, a resource amount management unit 402, a biofuel generation monitoring unit 403, a biomass power generation monitoring unit 404, a power supply control unit 405, a user information management unit 406, and a transaction information management unit 407. In addition, as the databases (to be referred to as DBs hereinafter) of various kinds of information, a storage amount information DB 408, a material stock information DB 409, an operation information DB 410, a user information DB 411, and a transaction information DB 412 are provided.

The storage amount management unit 401 monitors the state of a storage facility 450 of biofuel and updates the contents of the storage amount information DB 408, thereby managing the storage amount of the biofuel. As the biofuel here, liquid fuels such as bioethanol and biodiesel (Bio Diesel Fuel) as described above will be exemplified. In addition, the storage amount management unit 401 monitors an electric storage facility 460 and updates the contents of the storage amount information DB 408, thereby managing the stored power amount. A description will be made assuming that the power stored in the electric storage facility 460 is the power generated by the biomass power generation facility 106. That is, the power generated by the biomass power generation facility 106 is consumed in the facility associated with the CEMS 104, and is also supplied to an external unit or stored in the electric storage facility 460. In addition, even in a case in which the biomass power generation facility 106 does not generate power, if the transaction price of power from the outside is low, and the electric storage facility 460 has a capacity, control may be done to receive power supplied from the outside and store the power in the electric storage facility 460.

The resource amount management unit 402 monitors the state of a storage facility 440 that holds various kinds of biomass resources in which biomass resources provided from users are classified, and manages the storage amounts of the various kinds of resources. Information concerning the storage amount here is held by the material stock information DB 409. Biomass resources are managed for each type or application purpose.

The biofuel generation monitoring unit 403 monitors the state of a generation facility 430 configured to generate biofuel in the self-facility, and manages the operation state. Operation information here is held by the operation information DB 410. The operation information includes a ratio to the maximum operation capability (production capability), the schedule of operation, power consumption prediction, and the like.

The biomass power generation monitoring unit 404 monitors the state of a biomass power generation facility 420 in the self-facility, and manages the operation state. Operation information here is held by the operation information DB 410. The operation information includes a ratio to the maximum operation capability (power generation capability), the schedule of operation, the degree of consumption of a biomass resource, and the like.

The power supply control unit 405 controls switching of a power line used to supply power in accordance with the demand and surplus of power in the self-facility. More specifically, the power supply control unit 405 controls whether to use (or store) power obtained by biomass power generation in the self-facility or supply the power to the external unit.

The user information management unit 406 manages the information of the user who provides the biomass resource to the self-facility. The user information is held by the user information DB 411. The user information includes the amount and classification of a provided biomass resource, the contract contents, the information of incentive, and the like.

The transaction information management unit 407 manages the transaction information of power or biofuel. The transaction information is held by the transaction information DB 412. The transaction information includes the timing of transaction, the transaction price, the transaction partner, and the like.

[VPP]

The outline of the VPP (Virtual Power Plant) according to this embodiment will be described.

The VPP aims at managing the resources and operation states of a plurality of power generation bases and integrally causing them to function as a power supply means. In one power generation base, if there is a limitation on the power generation amount or the like, the plurality of power generation bases are made to cooperate, thereby enabling efficient supply of power or optimization of the balance between demand and supply.

In this embodiment, as shown in FIG. 1, the VPP management system 102 causes the plurality of power generation facilities such as the biomass power generation facility 106 managed by the CEMS 104 to cooperate, thereby controlling and managing the power generation facilities as one power generation system. The VPP management system 102 predicts and manages the operation state of each facility, surplus power, and the like. Also, as described above, the biomass power generation facility 106 or the like managed by the CEMS 104 also operates as a consumer in accordance with its function and operation state and therefore not only generates power but also consumes power. Hence, the VPP management system 102 performs management for such a consumption state as well.

The relay facility 103 has a function of connecting each power generation base and the VPP management system 102 and performs control based on the contract and the like between the user on the side of the power generation facility associated with the CEMS 104 and the operation company on the side of the VPP management system 102.

In this embodiment, to effectively use the power generated by the biomass power generation facility 106 associated with the CEMS 104, effective use of surplus power obtained by the biomass power generation is implemented in cooperation with the VPP management system 102.

[Processing Procedure]

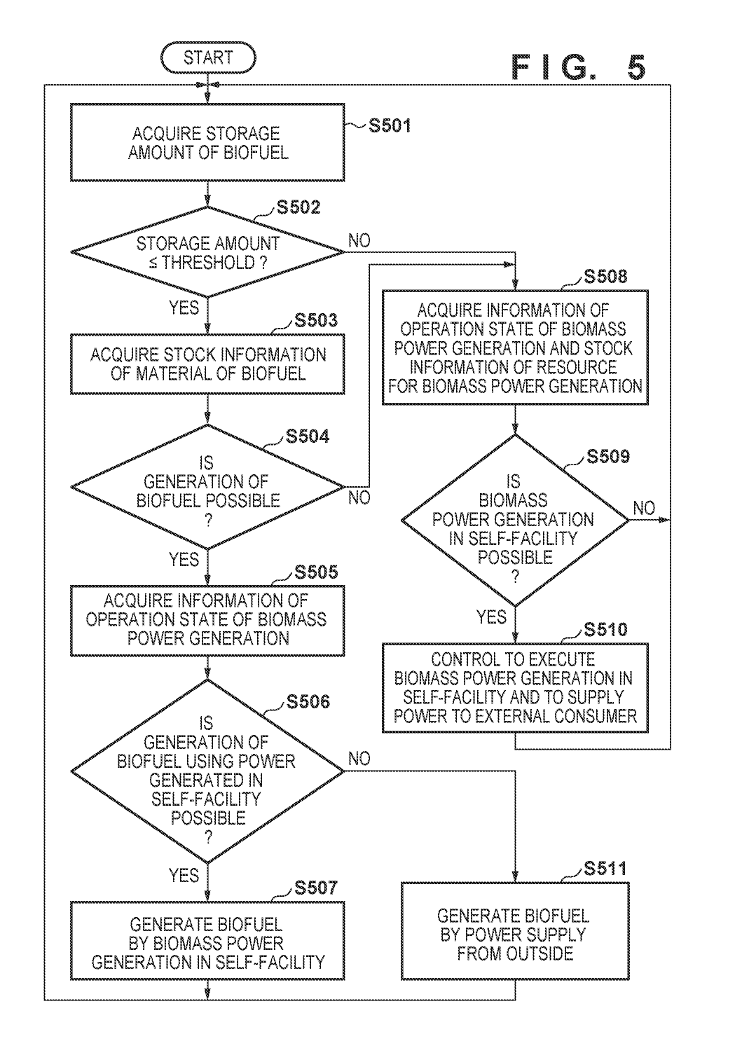

FIG. 5 shows a processing procedure concerning control according to this embodiment. This processing is implemented when the CPU 202 of the information processing apparatus functioning as the CEMS 104 reads out and executes a program stored in a storage unit such as the ROM 204.

In step S501, the CPU 202 acquires information concerning the storage amount of biofuel.

In step S502, the CPU 202 determines whether the current storage amount of biofuel is equal to or less than a predetermined threshold. The predetermined threshold here is defined based on a capacity such as a space to store actual biofuel. That is, if the storage amount exceeds the predetermined threshold, the storage space for biofuel does not exist. This indicates that the generation of biofuel needs to be suppressed. Note that the present invention is not limited to this arrangement. For example, the threshold may be set based on the sum of a minimum amount that needs to be stored to prepare for emergencies such as a disaster and a consumption amount assumed by prediction of consumption of biofuel. For example, the threshold may be changed in accordance with the season or the presence/absence of an event. If the storage amount is equal to or less than the threshold (YES in step S502), the process advances to S503. If the storage amount exceeds the threshold (NO in step S502), the process advances to S508.

In step S503, the CPU 202 acquires the stock information of the material of biofuel. The stock information of biofuel here indicates the amount of a resource serving as the material of biofuel in the classified resources, and corresponds to the above-described resource B.

In step S504, the CPU 202 determines, based on the information acquired in step S503, whether generation of biofuel is possible. If generation of biofuel is possible (YES in step S504), the process advances to S505. If generation is impossible (NO in step S504), the process advances to S508.

In step S505, the CPU 202 acquires the information of the operation state of biomass power generation in the self-facility.

In step S506, the CPU 202 determines whether biofuel can be generated by power obtained by the biomass power generation in the self-facility. For example, power necessary for generation of biofuel may be predicted in accordance with the generation amount, and the determination may be done based on the predicted value. If generation is possible (YES in step S506), the process advances to S507. If generation is impossible (that is, power shortage) (NO in step S506), the process advances to S511.

In step S507, the CPU 202 instructs to control the power supply line so as to generate biofuel using power obtained by executing biomass power generation in the self-facility. After that, the process returns to S501.

In step S508, the CPU 202 acquires the information of the operation state of biomass power generation in the self-facility and the stock information of the resource for biomass power generation. The resource for biomass power generation here indicates the amount of a resource used to perform biomass power generation in the classified resources, and corresponds to the above-described resource A.

In step S509, the CPU 202 determines, based on the information acquired in step S508, whether biomass power generation is possible. If biomass power generation is possible (YES in step S509), the process advances to S510. If biomass power generation is impossible (NO in step S509), the process returns to S501.

In step S510, the CPU 202 instructs to control the power supply line so as to supply power obtained by executing biomass power generation in the self-facility to the external unit. After that, the process returns to S501.

In step S511, the CPU 202 instructs to control the power supply line so as to receive power supply from the external unit. Generation of biofuel is performed using the power supplied from the external unit. After that, the process returns to S501.

(Transaction Management Processing)

In this embodiment, a user who provides a biomass resource and transaction of biofuel or power generated using the provided biomass resource are associated, and an incentive is given to each user. The incentive is given to promote providing of the biomass resource and efficiently collect the resource. The application purpose or the contents of the incentive are not particularly limited.

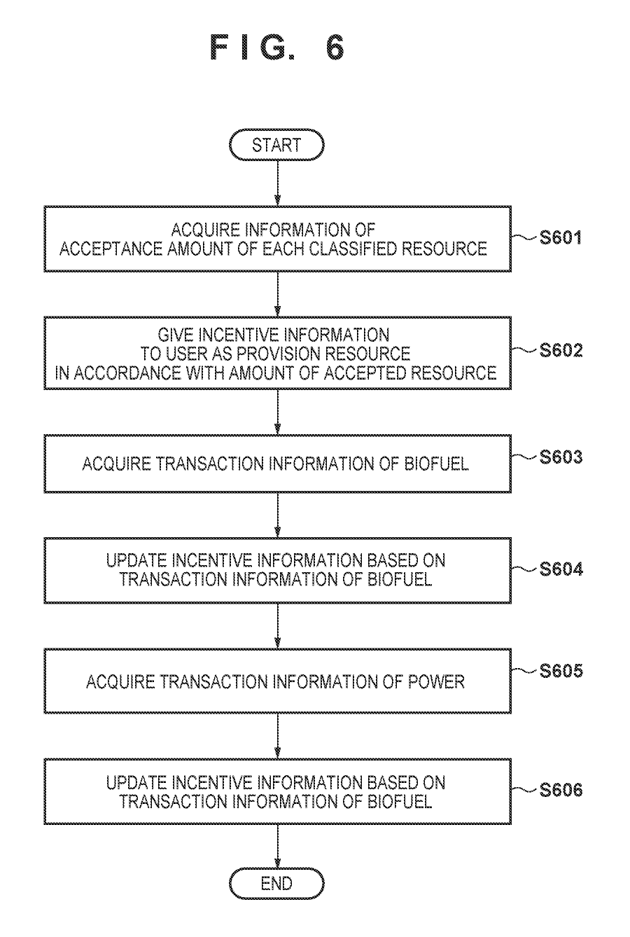

FIG. 6 is a flowchart for explaining processing concerning transaction management according to this embodiment. This processing is implemented when the CPU 202 of the information processing apparatus functioning as the CEMS 104 reads out and executes a program stored in a storage unit such as the ROM 204.

In step S601, the CPU 202 acquires the information of the acceptance amount of each resource provided by a user and classified.

In step S602, the CPU 202 gives an incentive to each user in accordance with the amount of the accepted resource. The type of the resource, or the contents or calculation formula of the incentive to be given in accordance with the amount of the resource may be changed.

In step S603, the CPU 202 acquires the transaction information of biofuel generated in the self-facility. Examples of the transaction information of biofuel are a transaction price, a transaction amount, and the use purpose of biofuel.

In step S604, the CPU 202 updates the incentive information of each user based on the transaction information acquired in step S603. For example, if the transaction price at the time of transaction is high, or if the transaction amount is large, the incentive may be given in accordance with the amount of the provided resource. In addition, if the user himself/herself is a customer, processing of preferentially providing biofuel in accordance with the incentive may be performed. Furthermore, if biofuel is to be used in an emergency such as a disaster, the incentive information may be updated without considering the transaction price and the like.

In step S605, the CPU 202 acquires the transaction information of power in the self-facility. The transaction information here includes the consumption amount, in the self-facility, of power generated by biomass power generation in the self-facility, the supply amount to an external consumer, the amount of power received from an external system power supply, the transaction price, the supply time zone, and the like. The transaction information here may be acquired from information managed in the facility and also from, for example, the VPP management system 102.

In step S606, the CPU 202 updates the incentive information of each user based on the transaction information acquired in step S605. For example, if the transaction price is high, or the transaction amount is large when supplying power to an external consumer, the incentive may be given in accordance with the amount of the provided power. The transaction here may be configured to operate power generated in the self-facility in cooperation with the VPP management system 102. The processing procedure then ends.

As described above, according to this embodiment, it is possible to effectively use a biomass resource in a region and appropriately supply and operate surplus power obtained by power generation using the biomass resource.

In addition, according to this embodiment, excessive power (surplus power) in power generated by biomass power generation can be stored in the facility or supplied to a system as a resource of VPP while ensuring liquid fuel. More specifically, when the electric storage facility in the facility is charged, and the power is sold in accordance with an instruction of the operation company that provides the VPP service, profits can be obtained by the operation of the surplus power. Additionally, even in a case in which necessary power cannot be obtained by biomass power generation, when power from the external unit is ensured directly or in a charging facility in a state in which the system power is excessive, and the power price is low for demand promotion, the power can also be used to generate liquid fuel. Furthermore, when the power ensured in the charging facility or the power obtained by biomass power generation is operated, profits in normal time can be ensured.

In addition, to efficiently perform biomass power generation, an appropriate incentive is given to each resource provider, thereby enabling the resource to be efficiently collected.

### OTHER EMBODIMENTS

In the above-described embodiment, when the storage amount of biofuel exceeds the threshold, control is performed to supply power generated by biomass power generation as surplus power to an external consumer. However, the present invention is not limited to this, and, for example, when the storage amount of biofuel exceeds the threshold, and charging of the electric storage facility is completed, the power may be supplied to the external consumer. Alternatively, priority may be given to charging of the electric storage facility, and after that, biofuel may be generated, and the power may be supplied to the external consumer when the storage amount exceeds the threshold.

This makes it possible to switch the subject to be preferentially stored in accordance with a predetermined purpose (providing of a power supply or biofuel in case of a disaster) or the like.

In addition, at the time of supply to the external consumer, the transaction price of the subject to be supplied may be determined. If the price is lower than a predetermined transaction price, supply to the external consumer may be inhibited.

Examples of an organization that provides the relay facility described in the above embodiment are a store of electric vehicles and a company that provides a charging station for electric motorcycles and the like.

As the contents of the given incentive, the user may be allowed to preferentially receive provided biofuel or may be given a preferential treatment concerning the transaction price (discount). In addition, the incentive may be given as money or points. The contents of the incentive may be switched in accordance with the profits of power operation. Alternatively, the contents of the incentive given to the user may be changed in accordance with the contract. For example, when providing biofuel, it is predicted that the consumption increases in a camp season such as summer, and an incentive to provide biofuel preferentially (or at a lower price) may be given.

In addition, when biomass power generation is used for VPP, not only effective use of surplus power but also an environment friendly effect (for example, CO₂ free) can be implemented.

### SUMMARY OF EMBODIMENT

According to the above-described embodiment, there is provided an energy storage system (for example, 400, 106, 430, 440, 450, 460) comprising:

a generation unit (for example, 430) configured to generate liquid fuel using power by renewable energy;

a storage unit (for example, 450) configured to store the liquid fuel generated by the generation unit; and

a storage amount management unit (for example, 400, 401, 405) configured to control the generation unit and monitor a storage amount in the storage unit, wherein when the storage amount in the storage unit exceeds a predetermined threshold, the storage amount management unit performs switching such that the power is operated by an operation company of power.

According to this embodiment, it is possible to give the highest priority to ensuring of energy in an amount necessary at the time of a disaster or the like using the liquid fuel that is easy to store, and obtain profits by operating power.

The energy storage system according to the above-described embodiment further comprises a biomass power generation unit (for example, 106) configured to generate power by the renewable energy, and the power generated by the biomass power generation unit is used as the power.

According to this embodiment, it is possible to use a biomass resource available in a region and use CO₂-free power obtained by power generation.

In the energy storage system according to the above-described embodiment,

the storage amount management unit performs switching such that the generation unit accepts power from an external unit, which is operated by the operation company, and

the generation unit generates the liquid fuel using the power obtained by the biomass power generation unit and the power from the external unit.

According to this embodiment, when surplus power can be inexpensively used, the cost of liquid fuel generation can be reduced by using the power of the system as well.

In the energy storage system according to the above-described embodiment,

when the storage amount in the storage unit is less than the predetermined threshold, the storage amount management unit performs switching such that the generation unit accepts power from an external unit, which is operated by the operation company, and

the generation unit generates the liquid fuel using the power obtained by the biomass power generation unit and the power from the external unit.

According to this embodiment, it is possible to generate the liquid fuel at a low cost by using the power obtained by the biomass power generation and inexpensive surplus power from the system.

In the energy storage system according to the above-described embodiment, the storage amount management unit manages a user who provides a biomass material and information of an incentive given to the user in association with each other.

According to this embodiment, when the incentive is given, a motivation to provide a biomass resource can be produced, and resource collection can smoothly be performed.

In the energy storage system according to the above-described embodiment,

the incentive is given to the user in accordance with an amount of power operated by the operation company in the power obtained by the biomass power generation unit and information of the biomass material provided by the user.

According to this embodiment, when the incentive is set based on the provided amount of the biomass resource and the profits of power operation, the motivation to provide the resource can be enhanced.

In the energy storage system according to the above-described embodiment,

the storage amount management unit

manages transaction information of the liquid fuel, and

decides an amount of the liquid fuel that can be provided to the user from the liquid fuel stored in the storage unit, based on the information of the incentive of the user and the transaction information when providing the liquid fuel.

According to this embodiment, the stored liquid fuel can be used in accordance with the given incentive.

In the energy storage system according to the above-described embodiment,

the energy storage system comprises an electric storage unit (for example, 460) configured to store power, and

when the storage amount in the storage unit exceeds the predetermined threshold, the storage amount management unit causes the electric storage unit to store the power obtained by the renewable energy.

According to this embodiment, when the liquid fuel can be ensured, power can be stored for an operation, and therefore, power operation can flexibly be performed.

In the energy storage system according to the above-described embodiment,

the predetermined threshold is set based on at least one of a scale of a subject to which the liquid fuel stored in the storage unit is provided and a period.

According to this embodiment, not only fuel supply in a disaster but also a temporary fuel demand or the like is assumed as the application purpose of the liquid fuel, thereby storing an appropriate amount of fuel.

According to the above-described embodiment, there is provided a management apparatus comprising:

an acquisition unit (for example, 401) configured to acquire information of a storage amount in a storage unit (for example, 450) configured to store liquid fuel generated by a generation unit (for example, 403) using power by renewable energy; and

an instruction unit (for example, 405) configured, when the storage amount in the storage unit exceeds a predetermined threshold, to instruct switching of supply of power such that the power is used for an application purpose different from generation of the liquid fuel by the generation unit.

According to this embodiment, if the storage amount of biofuel exceeds a predetermined threshold when the biofuel is generated using power by renewable energy, the application purpose of power is switched, thereby effectively using the power while storing an appropriate amount of biofuel.

What is claimed is:

1. An energy storage system comprising:
a generation unit configured to generate liquid fuel using power by renewable energy;
a storage unit configured to store the liquid fuel generated by the generation unit; and
a storage amount management unit configured to control the generation unit and monitor a storage amount in the storage unit,
wherein when the storage amount in the storage unit exceeds a predetermined threshold, the storage amount management unit performs switching such that the power is operated by an operation company of power.

2. The system according to claim 1, further comprising a biomass power generation unit configured to generate power by the renewable energy,
wherein the power generated by the biomass power generation unit is used as the power.

3. The system according to claim 2, wherein the storage amount management unit performs switching such that the generation unit accepts power from an external unit, which is operated by the operation company, and
the generation unit generates the liquid fuel using the power obtained by the biomass power generation unit and the power from the external unit.

4. The system according to claim 2, wherein when the storage amount in the storage unit is less than the predetermined threshold, the storage amount management unit performs switching such that the generation unit accepts power from an external unit, which is operated by the operation company, and
the generation unit generates the liquid fuel using the power obtained by the biomass power generation unit and the power from the external unit.

5. The system according to claim 2, wherein the storage amount management unit manages a user who provides a biomass material and information of an incentive given to the user in association with each other.

6. The system according to claim 5, wherein the incentive is given to the user in accordance with an amount of power operated by the operation company in the power obtained by the biomass power generation unit and information of the biomass material provided by the user.

7. The system according to claim 5, wherein the storage amount management unit
manages transaction information of the liquid fuel, and
decides an amount of the liquid fuel that can be provided to the user from the liquid fuel stored in the storage unit, based on the information of the incentive of the user and the transaction information when providing the liquid fuel.

8. The system according to claim 1, wherein the energy storage system comprises an electric storage unit configured to store power, and
when the storage amount in the storage unit exceeds the predetermined threshold, the storage amount management unit causes the electric storage unit to store the power obtained by the renewable energy.

9. The system according to claim 1, wherein the predetermined threshold is set based on at least one of a scale of a subject to which the liquid fuel stored in the storage unit is provided and a period.

10. A management apparatus comprising:
an acquisition unit configured to acquire information of a storage amount in a storage unit configured to store liquid fuel generated by a generation unit using power by renewable energy; and
an instruction unit configured to, when the storage amount in the storage unit exceeds a predetermined threshold, instruct switching of supply of power such that the power is used for an application purpose different from generation of the liquid fuel by the generation unit.
